(19) United States
(12) Patent Application Publication
(10) Pub. No.: US 2025/0058432 A1
(43) Pub. Date: Feb. 20, 2025

(54) SYSTEM FOR AUTONOMOUSLY CHANGING A SANDING PAD OF A SANDING HEAD

(71) Applicant: GrayMatter Robotics Inc., Gardena, CA (US)

(72) Inventors: Miguel A. Chavez-Garcia, Gardena, CA (US); Satyandra K. Gupta, Gardena, CA (US); Ariyan M. Kabir, Gardena, CA (US); Vihan Krishnan, Gardena, CA (US); Ashish Kulkarni, Gardena, CA (US); Ceasar G. Navarro, Gardena, CA (US); Husein M. Noble, Gardena, CA (US); Martin G. Philo, Gardena, CA (US); Christian A. Salinas, Gardena, CA (US); Brual C. Shah, Gardena, CA (US)

(21) Appl. No.: 18/234,814

(22) Filed: Aug. 16, 2023

(51) Int. Cl. B24D 9/08; B24B 49/12; B24B 49/18

(52) U.S. Cl. CPC B24D 9/085; B24B 49/12; B24B 49/186

(57) ABSTRACT

A system includes: a pad removal assembly; a replacement pad reservoir; an inspection unit; and a controller. The pad removal assembly includes: a separating element arranged proximal a slot; and a guide surface opposite the separating element. The replacement pad reservoir: arranged adjacent the separating element and housing sanding pads configured to couple the sanding head; and including an aperture in alignment with the guide surface. The inspection unit includes an optical sensor defining a field of view directed toward an imaging plane. The controller configured to: access an image recorded by the optical sensor depicting an abrasive area of a sanding pad arranged on a sanding head; extract features from the image; interpret an abrasive degradation for the abrasive area in the image based on the features; and in response to the abrasive degradation exceeding a threshold degradation, triggering a tool change cycle.

### CROSS-REFERENCE TO RELATED APPLICATIONS

This Application is a related to U.S. application Ser. No. 17/390,885, filed on 31 Jul. 2021, Ser. No. 18/087,725, filed on 22 Dec. 2022, and Ser. No. 18/136,241, filed on 18 Apr. 2023, each of which is incorporated in its entirety by this reference.

### TECHNICAL FIELD

This invention relates generally to the field of automated finishing and more specifically to a new and useful system for automated wear tracking and replacement triggering of a sanding pad in the field of automated finishing.

### BRIEF DESCRIPTION OF THE FIGURES

FIG. 1 is a schematic representation of a system;

FIG. 2 is a schematic representation of the system;

FIG. 3 is a schematic representation of the system;

FIG. 4 is a schematic representation of the system;

FIG. 5 is a schematic representation of the system;

FIG. 6 is a schematic representation of the system; and

FIG. 7 is a schematic representation of the system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

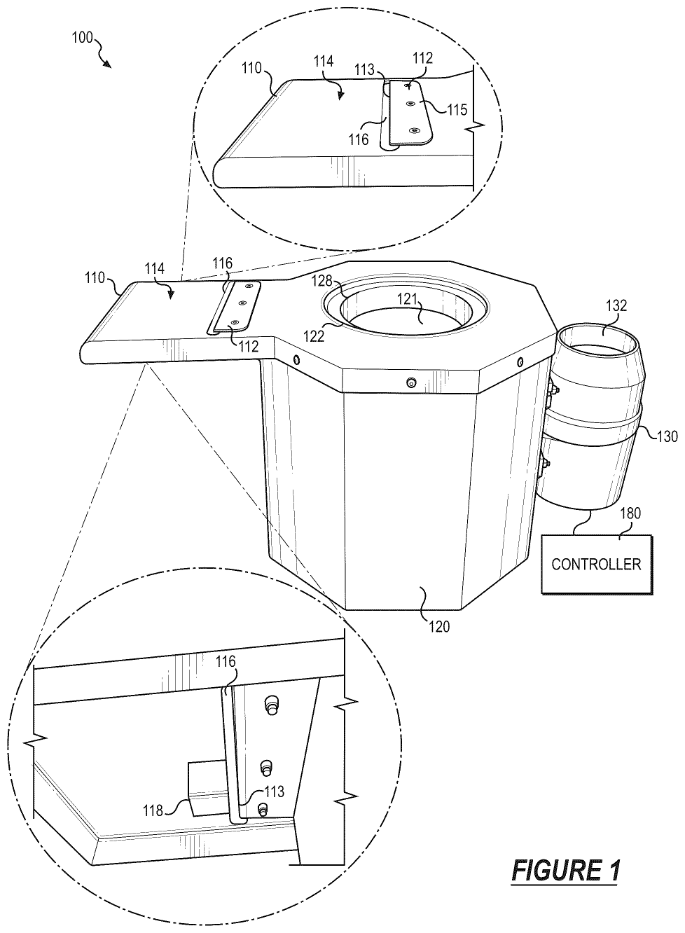

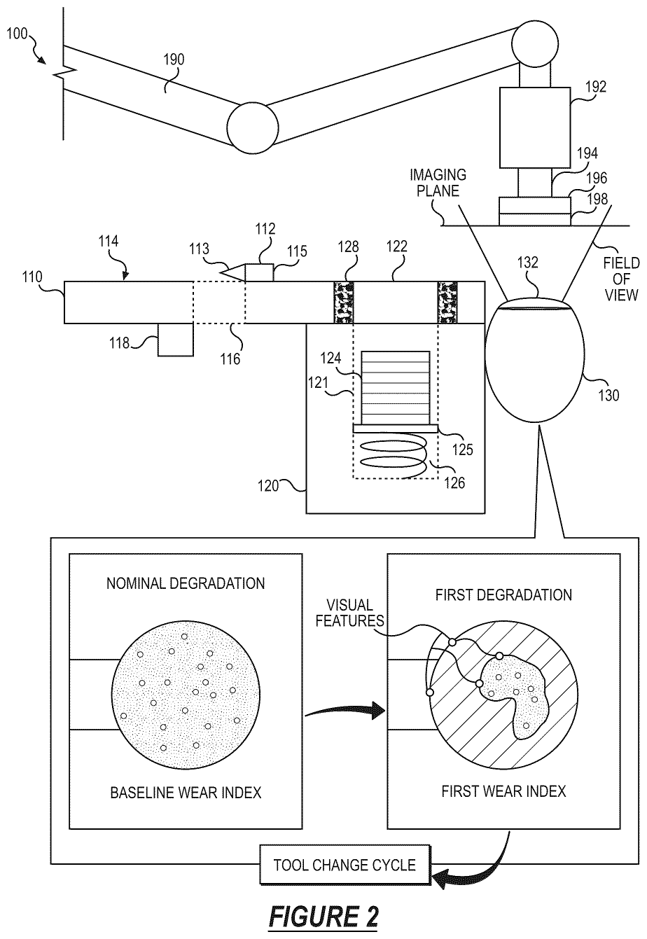

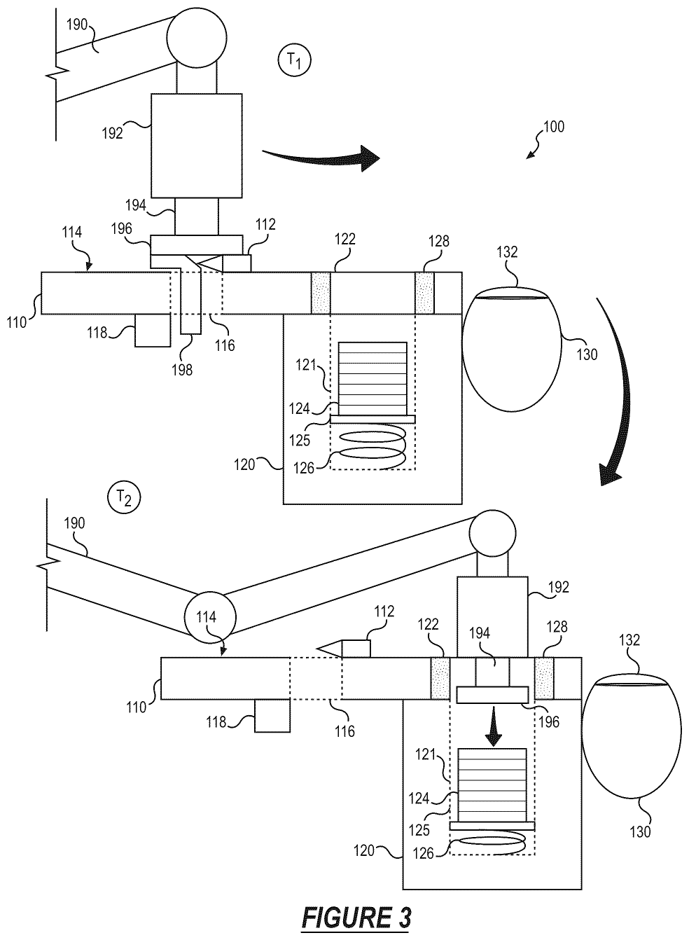

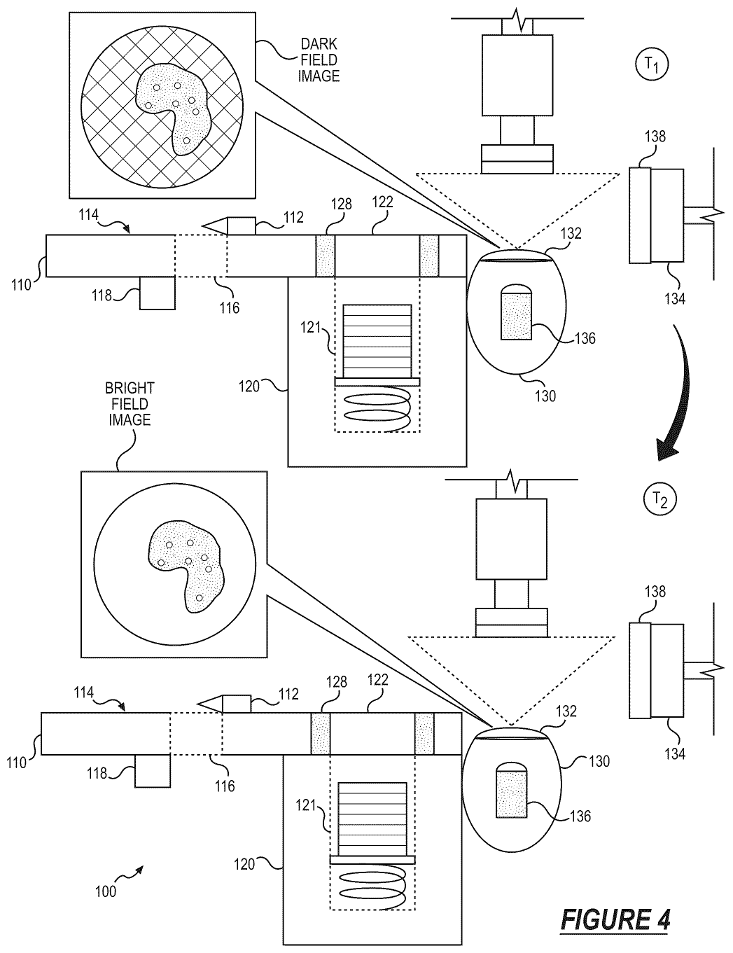

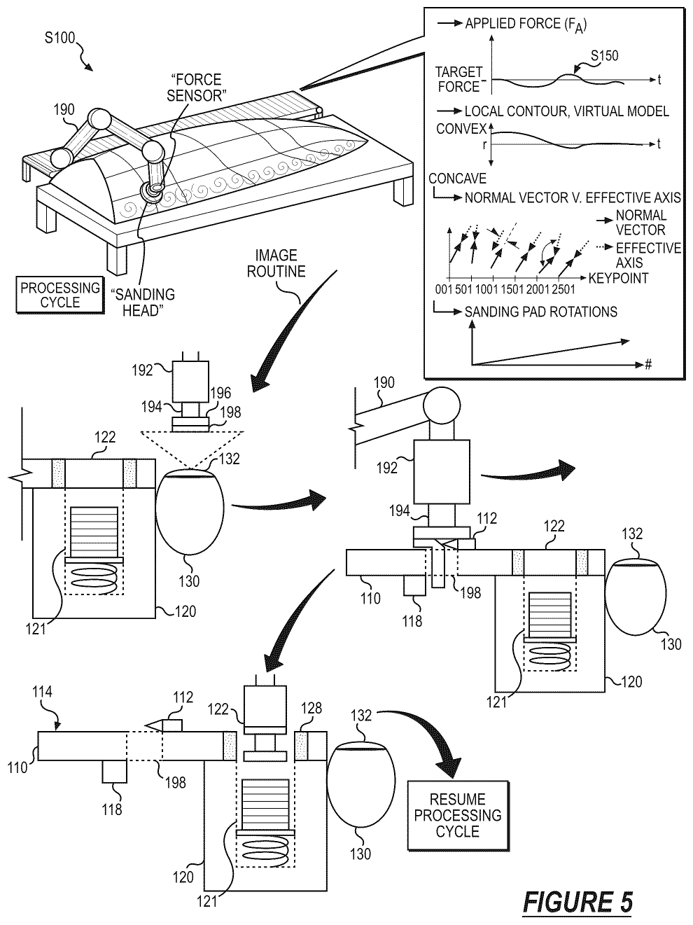

As shown in FIGS. 1, 2, and 3, a system 100 for changing a sanding pad 198 at a sanding head 194 includes: a pad removal assembly 110; a replacement pad reservoir 120; a first inspection unit 130; and a controller 180.

The pad removal assembly 110 includes: a waste receptable; a slot 116 arranged over the waste receptable; a guide surface 114 adjacent the slot 116 and configured to guide a sanding pad arranged on a sanding head 194, toward the slot 116; and a separating element 112 (e.g., a blade) facing the slot 116 opposite the guide surface 114, configured to separate the sanding pad from the sanding head during autonomous traversal of the sanding head across the guide surface 114, and configured to guide the sanding pad into the waste receptable.

The replacement pad reservoir 120, arranged adjacent the separating element 112: houses a set (e.g., a stack) of sanding pads 124 configured to couple the sanding head 194 (e.g., via a hook-and-loop interface or a pressure-sensitive adhesive); and includes an aperture 122 proximal (e.g., in plane with) the guide surface 114 and configured to receive the sanding head autonomously navigated into the reservoir toward the set of sanding pads.

The first inspection unit 130 includes an optical sensor 132 defining a field of view and configured to capture images of the sanding pad 198 arranged on the sanding head 194.

The controller 180 is configured to: trigger a set of actuators coupled to the sanding head to navigate the sanding head into the field of view of the optical sensor 113; access a first image recorded by the optical sensor 132 and depicting a first abrasive area of a first sanding pad 198 arranged on the sanding head occupying the field of view of the optical sensor 132; extract a first set of visual features from the first image; and interpret a first abrasive degradation for the first abrasive area in the first image based on the first set of features.

The controller 180 is also configured to, in response to the first abrasive degradation exceeding a threshold degradation, trigger a tool change cycle to: navigate the sanding head 194 across the guide surface 114 toward the separating element 112 to remove the first sanding pad 198 from the sanding head 194; and navigate the sanding head 194 within the replacement pad reservoir 120 to engage a second sanding pad 198, in the set of sanding pads 124, within the replacement pad reservoir 120 at the sanding head 194.

### 2. Applications

Generally, the system 100 functions as a tool changer for a sanding pad 198 transiently coupled to a sanding head 194 following application of the sanding head 194 on a work piece to: derive an abrasive degradation across surfaces of a worn sanding pad 198 transiently coupled to the sanding head 194; autonomously separate the worn sanding pad 198 from the sanding head 194 in response to the abrasive degradation exceeding a threshold degradation; and autonomously couple a mint (or “new”) sanding pad 198 at the sanding head 194 following separation of the worn sanding pad 198 from the sanding head 194.

In particular, the system 100 includes: an optical sensor 132 (e.g., color camera, depth sensor) defining a field of view and configured to capture an image of the worn sanding pad 198 arranged on the sanding head 194; a pad removal assembly 110 including a guide surface 114 arranged proximal a separating element 112 (e.g., blade) configured to guide the sanding head 194 toward a separating element 112 to remove the worn sanding pad 198 from the sanding head 194; and a replacement pad reservoir 120 arranged adjacent the pad removal assembly 110 and defining an interior cavity configured to contain a set of sanding pads 124 (e.g., a stack of sanding pads). Additionally, the system 100 cooperates with a robotic arm 190: arranged proximal a work area including the work piece; and including an end effector 192 arranged on a distal end of the robotic arm 190 and the sanding head 194 coupled to the end effector 192 configured to actuate the sanding pad 198.

In one example, following a target time window (e.g., 30 minutes) during a processing cycle corresponding to application of the sanding head 194 at a work piece, the system 100 can: pause application of the sanding head 194 at the work piece; navigate, such as via actuators at the robotic arm 190, the sanding head 194 proximal the optical sensor 132 to locate the worn sanding pad 198 at the sanding head 194 within a field of view of the optical sensor 132; and trigger the optical sensor 132 to capture a first image depicting an abrasive area across the worn sanding pad 198 arranged on the sanding head 194 (sanding head 194). The system 100 can then: implement computer vision techniques (e.g., deep learning) to extract a set of visual features from the first image; and interpret the abrasiveness across the abrasive area of the worn sanding pad 198 based on the set of visual features from the first image.

More specifically, the system 100 can: transform the set of visual features (e.g., pixels) from the first image into an wear index representing a degree of wear across the worn sanding pad 198 at the sanding head 194; and, in response to the wear index exceeding a threshold deviation from a nominal wear map representing a baseline degree of wear for a mint (or “new”) sanding pad 198 arranged on the sanding head 194, execute the tool change cycle to replace the worn sanding pad 198 at the sanding head 194 with a mint sanding pad 198 from the replacement pad reservoir 120.

Accordingly, during the tool change cycle, the system 100 can then: navigate the sanding head 194—including the worn sanding pad 198—in abutting engagement to the guide surface 114 of the pad removal assembly 110; and maneuver the sanding head 194 along a linear path to engage the worn sanding pad 198 at the sanding head 194 along a cutting edge 113 of the separating element 112, thereby removing the worn sanding pad 198 (e.g., worn sanding pad 198) from the sanding head 194. Additionally, the system 100 can then: locate the sanding head 194 over an aperture 122 of the replacement pad reservoir 120 defining a passageway toward the interior cavity containing the set of sanding pads 124 (e.g., set of sanding pads); and maneuver the sanding head 194 within the interior cavity of the replacement pad reservoir 120 to concentrically align the sanding head 194 with the set of sanding pads 124 within the interior cavity and apply a target force to induce coupling (e.g., via hook and loop fasteners) between an interface pad 196 at the sanding head 194 and a first sanding pad 198, in a set of sanding pads 124, arranged within the interior cavity.

Therefore, during a processing cycle corresponding to application of a sanding head 194 at a work piece, the system 100 can: routinely (e.g., every 30 minutes) derive an abrasive degradation for a worn sanding pad 198 at the sanding head 194; and replace the worn sanding pad 198 at the sanding head 194 with a mint (or “new”) sanding pad 198, thereby maintaining target performance of application of the sanding head 194 at the work piece during the processing cycle.

### 3. System: Robotic Arm

In one implementation described in U.S. patent application Ser. No. 18/111,470, the robotic system 100 includes: a robotic arm 190 arranged in or adjacent a work zone and that includes a set of articulable joints interposed between a series of arm segments; an end effector 192 supported on a distal end of the robotic arm 190; a sanding head 194 arranged on or integrated into the end effector 192 and configured to actuate (e.g., rotate) a sanding pad 198; an optical sensor 132 (e.g., a set of depth sensors and/or color cameras) arranged on or integrated into the end effector 192 and configured to capture optical images (e.g., depth maps, photographic color images) of a workpiece; a force sensor (e.g., a one-dimensional axial force sensor) configured to output a signal representing a force applied by the sanding head 194 to a workpiece normal to the sanding head 194; a set of position sensors configured to output signals representing (or assemblable into) a three-dimensional position of the end effector 192; a display configured to render a user interface accessible by an operator; and/or a controller 180 configured to execute Blocks of a method.

In this implementation, the system 100 can also include a conveyor configured to traverse the robotic arm 190 longitudinally along the work zone, such as to reach and process an elongated part defining a high length-to-width ratio (e.g., a high aspect ratio), such as a boat hull or aircraft wing.

In another implementation, the system 100 includes a multi-axis (e.g., five-axis) gantry configured to locate and articulate the end effector 192, sanding head 194, and optical sensor 132 across the work zone.

In yet another implementation shown in FIG. 6, the system includes: a mobile platform, such as including a wheeled or tracked chassis; a robotic arm arranged on the mobile platform; a sanding head (e.g., an end effector) arranged on a distal end of the robotic arm; and a navigation system. For example, the navigation system can include: a set of optical color and/or depth sensors arranged on the mobile platform and configured to capture images of a scene around the system; and a controller configured to autonomously navigate the mobile platform around a workpiece based on objects detected in images captured by these optical color and/or depth sensors.

However, the system can include or define any other element or structure.

### 4. System: Tool Changer

Generally, the system 100 includes a pad removal assembly 110, a replacement pad reservoir 120, and an inspection unit 130 forming a tool changer that cooperates with a robotic arm 190, as described above, to: autonomously separate a particular sanding pad 198 coupled to a sanding head 194 arranged on an end effector 192 of the robotic arm 190 at the pad removal assembly 110; and autonomously load a mint (or “new”) sanding pad 198 at the sanding head 194 by navigating the sanding head 194 within an interior of the replacement pad reservoir 120 containing a set of sanding pads 124 (e.g., a stack of sanding pads). In particular, the system 100 can: retrieve an image from an optical sensor 132 at the inspection unit 130 depicting an abrasive area of a sanding pad 198; and interpret an abrasive degradation for the abrasive area of the sanding pad 198 based on visual features extracted from the image. Thus, the system 100 can then: navigate the sanding head 194 across the pad removal assembly 110 to remove a worn sanding pad 198 from the sanding head 194; and navigate the sanding head 194 within the replacement pad reservoir 120 to couple a mint (or “new”) sanding pad 198 arranged within the replacement pad reservoir 120.

### 4.1 Pad Removal Assembly

In one implementation, the system 100 includes a pad removal assembly 110 including: a separating element 112 (e.g., blade) configured to receive the sanding pad 198 arranged on a sanding head 194; and a guide surface 114 arranged proximal the separating element 112 and configured to guide the sanding head 194 toward the separating element 112. In particular the system 100 can: trigger the robotic arm 190, such as in response to receiving a tool changing instruction from an operator, to maneuver the sanding head 194 across the pad removal assembly 110 in order to remove a current sanding pad 198 coupled to the sanding head 194; and maintain abutting engagement between the guide surface 114 and the sanding head 194 while the sanding head 194 traverses toward the separating element 112 (e.g., blade) to separate a sanding pad 198 coupled to the sanding head 194.

In this implementation, the guide surface 114: defines a rectangular region formed of a unitary metallic material (e.g., aluminum) proximal the separating element 112; and is configured to receive the sanding head 194 in abutting engagement with the guide surface 114. For example, the guide surface 114 can include an abrasion resistance coating (e.g., ceramic coating) configured to reduce wear resulting from abutting engagement of the separating element 112 against the guide surface 114 during removal of the sanding pad 198 coupled to the sanding head 194.

Additionally, the pad removal assembly 110 includes a slot 116: extending across a first lateral side of the guide surface 114 to define a lateral channel interposed between the guide surface 114 and the separating element 112; and defines a first edge proximal the guide surface 114 and a second edge, opposite the first edge, proximal the separating element 112. Accordingly, the separating element 112 can include a blade including: a spine 115 coupled proximal the second edge of the slot 116; and a cutting edge 113, arranged opposite the spine 115, partially extending across the channel and configured to receive the sanding pad 198 of a sanding head 194 and guide the sanding pad 198 within the slot 116 during separation of the sanding pad 198 from the sanding head 194.

In this implementation, the separating element 112 can be coupled to the second edge of the slot 116 via a set of threaded fasteners configured to maintain the separating element 112 at a target height above the guide surface 114. Accordingly, the set of threaded fasteners can be modified (e.g., turned clock wise, counter clock wise) to adjust the target height (e.g., increase height, decrease height) between the separating element 112 and the sanding pad 198 to accommodate varying sizes and dimensions of sanding pads coupled to the sanding head 194. Additionally, the separating element 112 includes fasteners configured to locate the separating element 112 to a target height in order to accommodate a gap for the sand disc backing thickness to achieve optimal detachment of the sanding pad from the interface pad.

In one example, during a tool change cycle, the system 100 can: locate (e.g., by maneuvering the end effector 192) the sanding head 194 including a sanding pad 198 in abutting engagement with the guide surface 114; and maneuver the sanding head 194 along a linear path toward the separating element 112 while maintaining abutting engagement between the sanding head 194 and the guide surface 114. In this example, as the sanding head 194 engages the separating element 112: the cutting edge 113 of the blade slices between the interface pad 196 arranged on the sanding head 194 and the sanding pad 198 coupled to the interface pad 196 (e.g., via hook and loop fastener connection); and the sanding pad 198 is guided through the slot 116 as the blade separates the sanding pad 198 from the interface pad 196 (e.g., coupled via hook and loop fastener connection) at the sanding head 194, thereby separating the sanding pad 198 from the sanding head 194. In this example, the system 100 can also include a waste receptacle: arranged below the slot 116 of the pad removal assembly 110; and configured to retain the worn sanding pads dispensed from the slot 116 of the pad removal assembly 110. An operator can thus, routinely dispose of the worn sanding pads within the waste receptacle to accommodate continued operation of the pad removal assembly 110.

In the aforementioned implementation, the system 100 can also include a deflector pad 118: arranged proximal the first edge of the slot 116 and below the guide surface 114; defining a vertical plane arranged normal to the guide surface 114; and configured to maintain the first sanding pad 198 in a target vertical pose through the slot 116 during separation of the first sanding pad 198 from the sanding head 194. Thus, the system 100 can repeatedly dispense worn sanding pads from the slot 116 in a target vertical pose to prevent contact of the abrasive surface of the worn sanding pads against components of the pad removal assembly 110 and/or the replacement pad reservoir 120. The deflector pad 118 is arranged below the separating blade 112 configured to guide the sanding pads removed from the sanding head 194 downward towards the waste receptacle to prevent crashing (or “interference”) between the sanding pad 192 and the separating element fasteners and the replacement pad reservoir 120.

Therefore, the system 100 can execute tool change cycles to: maneuver a sanding head 194 including a sanding pad 198 across the pad removal assembly 110 to separate the sanding pad 198 from the sanding head 194; and repeatedly dispense the worn sanding pads from the slot 116 at the pad removal assembly 110 to prevent contact of the worn sanding pads against components of the system 100.

### 4.2 Reservoir

In one implementation, the system 100 includes a replacement pad reservoir 120: arranged adjacent the pad removal assembly 110; defining a cylindrical volume configured to store a set of sanding pads, such as a vertical stack of the sanding pads arranged within an interior cavity of the replacement pad reservoir; and including an aperture 122 arranged on a first end of the replacement pad reservoir forming a passageway into the interior cavity of the replacement pad reservoir including the set of sanding pads. In particular, the system 100 can include: the replacement pad reservoir 120 and the pad removal assembly 110 forming a unitary structure; and the aperture 122 of the replacement pad reservoir arranged adjacent the separating element 112 of the pad removal assembly 110. In this implementation, the guide surface 114: defines a planar region that extends across the top end of the replacement pad reservoir 120 and includes the aperture 122 formed into the planar structure to define a passageway into the interior cavity of the replacement pad reservoir; and forms a linear path from removal of the sanding pad 198 from the sanding head 194 at the pad removal assembly 110 to retrieval of a mint (or “new”) sanding pad 198 contained within the interior cavity of the replacement pad reservoir 120.

Accordingly, the system 100 can then: maneuver the sanding head 194 within the interior cavity of the replacement pad reservoir 120 via the aperture 122 to engage a set of sanding pads arranged within the replacement pad reservoir 120; and apply a target force at the sanding head 194 toward the set of sanding pads to couple a mint sanding pad 198, in the set of sanding pads within the replacement pad reservoir 120, to the sanding head 194, such as coupling via hook and loop fasteners between a first side of the mint sanding pad 198 and the interface pad 196 coupled to the sanding head 194. In this implementation, an operator interacting with the system 100 can routinely load the stack of sanding pads into the replacement pad reservoir 120 to maintain a supply of sanding pads at the replacement pad reservoir 120.

In one example, the system 100 includes the replacement pad reservoir 120 defining a cylindrical volume 121 configured to contain a set of sanding pads and includes a first radial aperture 122 arranged on a first end of the cylindrical volume 121. Additionally, the replacement pad reservoir 120 can further include: a platform 125 arranged within the cylindrical volume 121 at a second end, opposite the first end, and configured to vertically support the set of sanding pads within the replacement pad reservoir 120; and a spring element 126 arranged below the platform 125 and vertically supporting the platform 125 within the cylindrical volume 121. Furthermore, the system 100 can include a guide ring 128: arranged on the first end of the cylindrical volume 121 in alignment with the guide surface 114; and cooperating with the cylindrical volume 121 to form a passageway configured to guide the sanding head 194 toward the set of sanding pads 198 arranged within the cylindrical volume 121. In one variation of this example, the cylindrical volume 121 and the guide ring 128 can be formed of a molybdenum-disulfide filled nylon configured to reduce friction between the sanding head 194 and the replacement pad reservoir 120.

In the aforementioned example, during a tool change cycle, the system 100 can: maneuver the sanding head 194—absent a sanding pad 198 coupled to the interface pad 196—in concentric alignment over the aperture 122 of the replacement pad reservoir 120; and navigate the sanding head 194 within the interior cavity of the replacement pad reservoir 120 to engage the interface pad 196 of the sanding head 194 with the stack of sanding pads within the replacement pad reservoir 120.

In this example, the system 100 can execute canned cycles to navigate a sanding head 194 along a target path in order to: navigate the sanding head 194 along the target path across the pad removal assembly 110 to remove a worn sanding pad 198 from the sanding head 194; and, following removal of the worn sanding pad 198 from the sanding head 194, locate the sanding head 194 in concentric alignment with the aperture 122 of the replacement pad reservoir 120. The system 100 can then maneuver the sanding head 194 within the replacement pad reservoir 120 to engage the set of sanding pads within the replacement pad reservoir 120. In this example, the guide ring 128 and the cylindrical passageway of the replacement pad reservoir 120 cooperate to: horizontally constrain the sanding head 194 within the replacement pad reservoir 120; and maintain a target concentric pose of the sanding head 194, relative the set of sanding pads within replacement pad reservoir 120, to ensure concentric coupling between the interface pad 196 at the sanding head 194 and the mint sanding pad 198 within the replacement pad reservoir 120. Thus, the system 100 can then: maneuver the sanding head 194 through the guide ring 128 to locate the sanding head 194 within the replacement pad reservoir 120 to engage the set of sanding pads within the interior cavity; and apply a target force between the interface pad 196 at the sanding head 194 toward a mint sanding pad 198 within the interior cavity of the replacement pad reservoir 120 to couple the mint sanding pad 198 to the sanding head 194 (e.g., via hook and loop fastening mechanism).

In another example, the system 100 can: navigate the sanding head 194 proximal the aperture 122 of the replacement pad reservoir 120; and capture a first image from an optical sensor 132 arranged on the end effector 192 including the sanding head 194 and facing toward the aperture 122 of the replacement pad reservoir 120. In this example, the system 100 can then: extract a first set of features (e.g., edge detection) from the first image; and interpret a target pose of a mint sanding pad 198 depicted in the first image and located within the replacement pad reservoir 120. The system 100 can then: maneuver the sanding head 194 according to the target pose of the mint sanding pad 198 to concentrically align the sanding head 194 with the aperture 122 of the replacement pad reservoir 120; and subsequently navigate the sanding head 194 within the replacement pad reservoir 120 to retrieve a mint sanding pad 198 within the replacement pad reservoir 120.

Therefore, the system 100 can execute a tool change cycle to: maneuver a sanding head 194 over the replacement pad reservoir 120 containing a set of sanding pads configured to couple the sanding head 194; and navigate the sanding head 194 within the replacement pad reservoir 120 to maintain a target concentric pose during coupling of a mint sanding pad 198 within the replacement pad reservoir 120 and the interface pad 196 at the sanding head 194.

In another example, the replacement pad reservoir 120 defines a continuous cylinder (e.g., rather than axial-rods) forming a low clearance configured to concentrically locate the sanding head 194 within the replacement pad reservoir 120 during the tool change cycle. The replacement pad reservoir 120 further includes a lead-in chamber: arranged at a top end of the replacement pad reservoir 120 via bearings (e.g., free-rolling bearings); and configured to concentrically locate and align the sanding head 194 over the aperture 122 of the replacement pad reservoir 120. Additionally, the replacement pad reservoir 120 defines a smooth and continuous interior surface that cooperates with the lead-in chamber to form a low clearance configured to align the sanding head 194 traversing within the replacement pad reservoir 120. Thus, the sanding head 194 concentrically aligns within the replacement pad reservoir 120 during the tool change cycle. Furthermore, the replacement pad reservoir 120 includes an adjustable base configured to locate the sanding pads within the replacement pad reservoir 120 to a target vertical height.

### 4.3 Inspection Unit

Generally, the system 100 can include an inspection unit 130 including: an optical sensor 132 (e.g., color camera) defining a field of view of an imaging plane arranged opposite the guide surface 114; and a lighting module configured to output light toward the imaging plane at a particular angle or incidence (e.g., between parallel to the imaging plane or normal to the imaging plane). In particular, the system 100 can include an enclosure: arranged adjacent (e.g., coupled to) the replacement pad reservoir 120 containing the set of sanding pads; and locating the optical sensor 132 to define a field of view upward from the guide surface 114. Thus, the system 100 can: navigate the sanding head 194 proximal the optical sensor 132 to locate the sanding pad 198 arranged on the sanding head 194 within a field of the view of the optical sensor 132; trigger the lighting module to illuminate an abrasive area of the sanding pad 198; and trigger the optical sensor 132 to capture an image depicting the abrasive area of the sanding pad 198 prior to executing a tool change cycle at the pad removal assembly 110 and the replacement pad reservoir 120.

### 4.3.1 Inspection Unit: Optical Sensor

In one implementation, the inspection unit 130 is transiently coupled to the replacement pad reservoir 120 and includes an optical sensor 132 defining a field of view directed toward an imaging plane defined by the sanding head 194 arranged over the optical sensor 132. Generally, the inspection unit 130 is configured to transiently (i.e., removably) couple to the replacement pad reservoir 120 and includes an optical sensor 132 configured to record an image of abrasive surfaces of a sanding pad 198 of a sanding head 194 arranged over the inspection unit 130. For example, the optical sensor 132 can include: an area imaging sensor, such as an RGB or infrared, color or monochromatic, CMOS, CCD, or other camera configured to capture images (e.g., digital photographic color images) of sanding pads facing the optical sensor 132. The optical sensor 132 can additionally or alternatively include: a 3D imaging sensor, such as stereoscopic cameras, a structured light imaging system 100, or other depth sensor (e.g., an infrared depth camera) configured to output depth images, such as in the form of 3D point cloud images. Furthermore, the optical sensor 132 can include a lens focused to the image plane, defining the field of view including the net module, and defining a viewing axis perpendicular to the imaging plane.

However, the inspection unit 130 can include one or more sensors of any other type. For example, the inspection unit 130 can include an electronic test instrument (e.g., an oscilloscope and probes, profilometer), a surface profile station including a CNC surface profile gauge, or any other optical, acoustic, thermal, or other type of contact or non-contact sensor. (Alternatively, the system 100 can include one or more sensors, sensor actuators, etc. distributed across multiple modules.) The inspection unit 130 can further include a data bus configured to offload these images and/or other sensor data from the optical sensor 132—such as to a remote database, to the controller 180, or to a connected computing device (e.g., a laptop computer)—and the inspection unit 130 can further house the controller 180 as described below.

### 4.3.2 Inspection Unit: Lighting Modules

The system 100 further includes lighting modules configured to project artificial light proximal the imaging plane and to illuminate abrasive surfaces across a sanding pad 198 of the sanding head 194 within a field of view of the optical sensor 132 in preparation for recording an image of the unit at the inspection unit 130. In particular, the system 100 can include one or more dark-field lighting modules 138 configured to mount to the side of the enclosure or to the side of the replacement pad reservoir 120 and to illuminate surfaces of a sanding pad 198 located on the sanding pad 198 at substantially high angles of incidence (e.g., 90°+/−5°) relative to the viewing axis of the optical sensor 132 in preparation for recording a dark-field image, which can be particularly suitable for detecting defects (e.g., scratches, nicks, abrasions, tool marks, depressions, burrs, etc.) on illuminated surfaces of the abrasive area of the sanding pad 198. The system 100 can also include one or more bright-field lighting modules 136 configured to mount over the imaging volume, such as within the inspection unit 130, and to illuminate surfaces of the abrasive area of a sanding pad 198 located on the sanding head 194 at substantially low angles of incidence (e.g., 0°+/−10°) relative to the viewing axis of the optical sensor 132 in preparation for recording a bright-field image particularly suitable for detecting features on an abrasive area of the sanding pad 198, which can enable relatively accurate extraction of quantitative dimensions of these features of the sanding pad 198. The system 100 can further include a side lighting module: arranged vertically between a dark-field lighting module 138 adjacent the replacement pad reservoir 120 and the bright-field lighting module 136; and including a side light source configured to project light onto a surface of interest on an abrasive area of a sanding pad 198 at (predominantly) an angle between light output (predominantly) by the dark-field lighting module 138 and light output (predominantly) by the bright-field lighting module 136.

### 4.3.2.1 Dark-Field Lighting Module

In one implementation, the dark-field lighting module 138: includes a dark-field light source configured to output light across a light plane; includes a directional light filter extending across the dark-field light source, configured to pass light output by the dark-field light source substantially normal to the light plane, and configured to reject light output by the dark-field light source substantially nonparallel to the light plane; and is configured to transiently couple to the enclosure proximal the replacement pad reservoir 120 with a normal axis of the light plane substantially perpendicular to the abrasive area of the sanding pad 198 arranged on the sanding head 194.

In the aforementioned implementation, the dark-field lighting module 138 includes a light source facing the open volume and configured to output light across a light plane. In particular, the dark-field light source of the dark-field lighting module 138 includes a grid array of light elements arranged across the light plane. For example, the light source can include: a set of cold-cathode fluorescent lamps (CCFLs) spanning the light plane; a two-dimensional array of LEDs spanning the light plane; or a planar light guide spanning the light plane and one or more rows and columns of LEDs arranged about the perimeter of the light guide. However, the light source can include any other light source type configured to output light across an area (e.g., the light plane) or cluster of light sources (e.g., point sources) that cooperate to output light across an area.

The dark-field lighting module 138 can include a directional light filter: coupled to the light source between the light source imaging plane; configured to pass light output from the light source substantially normal to the light plane; and configured to reject light output from the light source at angles other than substantially normal to the light plane. In particular, the directional light filter functions to limit the maximum angle between light rays passed from the light source into the imaging plane between the inspection unit 130 and the sanding head 194, thereby limiting the angle of incident light rays on the abrasive area of a sanding pad 198—facing the optical sensor 132—at a similarly narrow angular range.

### 4.3.2.2 Bright-Field Lighting Module

The system 100 can also include a bright-field lighting module 136 transiently coupled to the enclosure proximal the optical sensor 132 and including a bright-field light source configured to output light toward the surface of interest (e.g., toward the image plane and substantially parallel to the viewing axis of the optical sensor 132). Generally, a dark-field lighting module 138 described above can illuminate the width and breadth of an abrasive area of a sanding pad 198 with directional light of substantially uniform intensity but can wash out edges of the abrasive area or otherwise provide limited contrast across abrasive surfaces at different levels within the abrasive area of the sanding pad 198. The system 100 can also include a bright-field lighting module 136 that projects toward and substantially normal to the abrasive area of the sanding pad 198 in order to cast shadows between surfaces of different levels in the abrasive area of the sanding pad 198. The controller 180 (or a remote computer system 100) can then implement machine vision (e.g., edge detection) techniques to identify wear index within a bright-field image.

Therefore, the bright-field lighting module 136 can illuminate abrasive areas of a sanding pad 198 arranged on the sanding head 194 with greater contrast due to occurrence of shadows along edge features on the sanding head 194. In one implementation, the bright-field lighting module 136 includes a ring of LEDs arranged in a circular pattern about a substrate and configured to mount to the inspection unit 130, such as on the optical sensor 132 concentric with and behind the lens of the optical sensor 132. The bright-field lighting module 136 can also include a directional light filter—as described above—with aperture 122s coaxial with the viewing axis of the optical sensor 132 lens such that the bright-field lighting module 136 projects light rays substantially normal to the image plane and at a substantially uniform intensity across abrasive areas of a sanding pad 198 arranged on the sanding head 194.

### 4.3.3 Variation: Reflective Surfaces

In one variation, the system 100 includes the inspection unit 130: arranged on the robotic arm 190 proximal the sanding head 194 coupled to the end effector 192; including an optical sensor 132 defining a field of view of the sanding head 194 arranged on the end effector 192; and including a lighting module (e.g., bright-field lighting module 136) arranged on the inspection unit 130 and configured to output light normal the field of view defined by the optical sensor 132. In this variation, the system 100 further includes a reflecting surface (e.g., mirror): arranged in alignment with the guide surface 114; and configured to reflect light toward the optical sensor 132 arranged on the robotic arm 190.

Accordingly, the system 100 can then: navigate the sanding head 194 proximal the reflective surface to locate the sanding pad 198 arranged on the sanding head 194 within a field of view of the optical sensor 132 at the robotic arm 190; trigger the optical sensor 132 at the robotic arm 190 to capture an image depicting the sanding pad 198 in the reflective surface opposite the optical sensor 132 at the robotic arm 190; and implement steps and techniques described below to interpret an abrasive degradation of the sanding head 194 based on visual features extracted from the image.

Therefore, the system 100 can: leverage the suite of sensors (e.g., optical sensor 132, lighting module) arranged on the robotic arm 190 to capture images depicting abrasive areas of a sanding pad 198 arranged on the sanding head 194; and record images at the optical sensor 132 arranged on the robotic arm 190—depicting a reflective surface directed toward the sanding pad 198—to interpret abrasive degradation at the sanding pad 198. Accordingly, the system 100 can: reduce reliance on the inspection unit 130 arranged proximal the replacement pad reservoir 120; and implement reflective surfaces to leverage sensors located on the robotic arm 190 to capture images of abrasive areas on the sanding pad 198 arranged on the sanding head 194.

### 5. Controller

Generally, the system 100 includes a controller 180, such as integrated within the inspection unit 130 coupled to the replacement pad reservoir 120 and/or arranged on a remote computer system 100 separate from the inspection unit 130, configured to: initiate an imaging routine to interpret abrasive degradation of an abrasive area for a sanding pad 198 depicted in an image captured at the optical sensor 132; and, in response to interpreting an abrasive degradation exceeding a threshold degradation for the sanding pad 198, execute a tool change cycle to remove a current sanding pad 198 from the sanding head 194 and subsequently load a mint (or “new”) sanding pad 198 retrieved from the replacement pad reservoir 120. In particular the system 100 can, following a processing cycle corresponding to application of the sanding head 194 on a work piece proximal the work zone: navigate the sanding head 194 proximal the optical sensor 132; capture an image depicting an abrasive area of the sanding pad 198 arranged on the sanding head 194; and interpret an abrasive degradation for the sanding pad 198 at the sanding head 194 based on a set of visual features extracted from the image.

Thus, in response to the abrasive degradation for the sanding pad 198 exceeding a threshold deviation from a threshold degradation, the system 100 can: maneuver the sanding head 194 across the pad removal assembly 110 to remove the sanding pad 198 from the sanding head 194; and navigate the sanding head 194 within the replacement pad reservoir 120 to retrieve a mint (or “new”) sanding pad 198 contained within the replacement pad reservoir 120. Accordingly, the system 100 can then initiate a second processing cycle corresponding to application of the sanding head 194—including the mint sanding pad 198—on the work piece proximal the work zone.

### 5.1 Controller: Imaging Routine

In one implementation, following a target time window during a processing cycle corresponding to application of the sanding head 194 on a work piece proximal the work area, the system 100 can: initiate an imaging routine to capture an image and/or a timeseries of images from the optical sensor 132 depicting an abrasive area at the sanding pad 198 arranged on the sanding head 194; and implement steps and techniques described below to interpret an abrasive degradation of the abrasive area of the sanding pad 198 based on visual features extracted from the image and/or timeseries of images. In particular, the system 100 can: at a first time, activate a set of lighting modules 134 (e.g., bright-lighting modules, dark-lighting modules) at the inspection unit 130 to illuminate the abrasive area of the sanding pad 198; and trigger the optical sensor 132 to capture an image and/or timeseries of images depicting the abrasive area of the sanding pad 198 at the first time during illumination of the abrasive area by the set of lighting modules 134. Accordingly, the system 100 can then: compute wear index using timeseries of images corresponding to the abrasive area of the sanding pad 198; and implement machine vision techniques to identify wear index within the image and/or time series of images based.

In one example, the system 100 can include a set of lighting modules 134 including a first lighting module including a bright-field light source and configured to output light normal the imaging plane. In this example, the system 100 can then execute an imaging routine to: retrieve a timeseries of images from the optical sensor 132 following a target time window during a processing cycle corresponding to application of the sanding head 194 on a work piece proximal the work zone; and detect presence of the sanding head 194 within a field of view of the optical sensor 132 in the timeseries of images. The system 100 can thus, in response to detecting presence of the sanding head 194 within a field of view of the optical sensor 132: at a first time, trigger the first lighting module, in the set of lighting modules 134, to illuminate the first abrasive area of the first sanding pad 198 at a first angle of incidence relative the first abrasive area; extract the first image, from the timeseries of images, depicting the first abrasive area of the first sanding pad 198 at the first time; and extract the first set of visual features from the first image. Accordingly, the system 100 can then interpret the first abrasive degradation of the first abrasive area of the first sanding pad 198 based on the first set of visual features from the first image.

In another example, the system 100 can include the set of lighting modules 134 including a second lighting module including a dark-field light source and configured to output light substantially parallel to the imaging plane. In this example, the system 100 can then, in response to detecting presence of the sanding head 194 within a field of view of the optical sensor 132: at a second time following the first time, trigger the second lighting module to illuminate the first abrasive area of the first sanding pad 198 at a second angle of incidence, different from the first angle of incidence, relative the first abrasive area; and extract a second image, from the timeseries of images, depicting the first abrasive area of the first sanding pad 198 at the second time. Accordingly, the system 100 can then: extract a second set of visual features from the second image; and interpret the first abrasive degradation of the first abrasive area of the first sanding pad 198 based on the first set of visual features from the first image and the second set of visual features from the second image.

Therefore, the system 100 can: trigger the lighting modules at the inspection unit 130 to illuminate the abrasive area across the sanding pad 198 arranged on the sanding head 194; extract wear index from the image corresponding to an abrasive area across the sanding pad 198 arranged on the sanding head 194; and trigger a tool change cycle in response to the wear index across the sanding pad 198 exceeding a threshold wear index.

### 5.2 Controller: Interpreting Abrasive Degradation

In one implementation, following a target time window in a processing cycle, the system 100 can: access a first image captured at the optical sensor 132 depicting an abrasive area of the sanding pad 198 arranged across the sanding head 194; extract a set of visual features from the first image; and generate a wear index representing degree of wear across the abrasive area depicted in the first image based on the first set of visual features. Accordingly, in response to the wear index for the abrasive area of the sanding pad 198 exceeding a threshold deviation from a nominal wear index, trigger a tool change cycle at the sanding head 194.

In one example, the system 100 includes an optical sensor 132 including an area imaging camera configured to capture color images of a sanding pad 198 arranged on the sanding head 194 within a field of view of the optical sensor 132. In this example, following a target time window during a processing cycle, the system 100 can then: navigate the sanding head 194 within the field of view of the optical sensor 132; trigger the optical sensor 132 to capture a first color image depicting the first sanding pad 198 arranged on the sanding head 194; and isolate a first region in the first color image corresponding to the first abrasive area of the first sanding pad 198. The system 100 can then: extract the first set of visual features from the first region; and generate a first pixel map including a set of pixels representing a first wear index across the first abrasive area based on the first set of visual features from the first region. The system can then interpret the first abrasive degradation based on differences between the first pixel map and a target pixel map representing a nominal wear index across the first abrasive area. Accordingly, in response to the first abrasive degradation exceeding a threshold degradation, the system 100 can then trigger the tool change cycle to remove the sanding pad 198 arranged on the sanding head 194 and load a mint (or “new”) sanding pad 198 at the sanding head 194.

In another example, the system 100 includes an optical sensor 132 including a depth sensor configured to capture depth images of a sanding pad 198 arranged on the sanding head 194 within a field of view of the optical sensor 132. In this example, the system 100 can then: following a target time window during a processing cycle, navigate the sanding head 194 within the field of view of the depth sensor; trigger the depth sensor to capture a first depth image depicting the first sanding pad 198 arranged on the sanding head 194; and isolate a first region in the first depth image corresponding to the first abrasive area of the first sanding pad 198. The system 100 can then: extract a first set of visual features from the first region; and generate a first depth map including a set of pixels representing a first surface profile across the first abrasive area of the first sanding pad 198 based on the first set of visual features from the first region. The system can then interpret the first abrasive degradation across the first abrasive area based on differences between the first depth map and a target depth map representing a target surface profile across the first abrasive area.

Accordingly, in response to the first abrasive degradation exceeding a threshold degradation, the system 100 can then trigger a tool change cycle.

Therefore, the system 100 can: output a wear index for a sanding pad 198; and trigger a tool change cycle at the sanding head 194 responsive to the abrasion index exceeding a threshold deviation from a nominal value.

### 5.2 Controller: Tool Change Cycle

In one implementation, in response to the abrasive degradation across the abrasive area of the sanding pad 198 arranged on the sanding head 194 exceeding a threshold degradation, the system 100 can trigger a tool change cycle to: navigate the sanding head 194 across the guide surface 114 toward the separating element 112 to separate the sanding pad 198 from the interface pad 196 at the sanding head 194; and subsequently, navigate the sanding head 194 within the replacement pad reservoir 120 to engage a mint (or “new”) sanding pad 198, in a set of sanding pads, located within the replacement pad reservoir 120.

In one example, during the tool change cycle, the system 100 can: at a first time, navigate the sanding head 194 to locate the first sanding pad 198 in abutting contact with the first guide surface 114; and maneuver the sanding head 194 along a linear path across the guide surface 114 toward a cutting edge 113 of the separating element 112 to separate the first sanding pad 198 from the sanding head 194 while guiding the first sanding pad 198 through the slot 116. In this example, the system 100 can then: at a second time following the first time, navigate the sanding head 194 over the aperture 122 of the replacement pad reservoir 120; and maneuver the sanding head 194 through the aperture 122 to apply a target force to the second sanding pad, in the set of sanding pads 124, contained within the replacement pad reservoir 120 to engage the second sanding pad at the sanding head 194. Thus, the system 100 can initiate a processing cycle corresponding to application of the sanding head 194 including the second sanding pad 198 on a workpiece proximal the work zone.

In another example, following a first time window during the processing cycle, the system 100 can: navigate the sanding head 194 including the second sanding pad 198 within the field of view of the optical sensor 132; trigger the optical sensor 132 to capture a second image depicting a second abrasive area of the second sanding pad 198 arranged on the sanding head 194; extract a second set of visual features form the second image; and interpret a second abrasive degradation for the second abrasive area in the second image based on the second set of features. The system 100 can then, in response to the second abrasive degradation falling below a target abrasive degradation, resume the processing cycle for a second time window according to the second abrasive degradation of the second sanding pad 198.

Therefore, during a processing cycle, the system 100 can: routinely (e.g., intervals of 30 minutes, 45 minutes) execute an imaging routine to derive an abrasive degradation across a sanding pad 198 arranged on the sanding head 194; and, in response to the abrasive degradation exceeding a threshold degradation, trigger a tool change cycle to replace the sanding pad 198 at the sanding head 194 and thereby maintain target abrasion contact during application of the sanding head 194 at a work piece.

### 5.3 Controller: Tool Installation Verification

In one implementation, following completion of the tool change cycle, the system 100 can execute a verification routine to confirm successful coupling of a mint (or “new”) sanding pad 198 at the sanding head 194.

In one example, following the tool change cycle, the system 100 can: navigate the sanding head 194 including the second sanding pad 198 within the field of view of the optical sensor 132; trigger the optical sensor 132 to capture a second image depicting the second sanding pad 198 arranged on the sanding head 194; extract a second set of visual features from the second image; and interpret a second pose of the second sanding pad 198 arranged on the sanding head 194 based on the second set of features. Accordingly, in response to the second pose of the second sanding pad 198 exceeding a threshold deviation from a target pose, the system 100 can trigger a second tool change cycle to: navigate the sanding head 194 across the guide surface 114 toward the separating element 112 to remove the second sanding pad from the sanding head 194; and navigate the sanding head 194 within the replacement pad reservoir 120 to engage a third sanding pad, in the set of sanding pads 124, within the replacement pad reservoir 120 at the sanding head 194.

Therefore, following completion of a tool change cycle, the system 100 can: derive a pose of the mint sanding pad 198 at the sanding head 194; and, in response to the pose of the mint sanding pad 198 deviating from a target pose, initiate a second tool change cycle to mitigate incorrect application of the sanding head 194 on the work piece.

### 5.4 Controller: Generating Nominal Abrasion Threshold

In one implementation, prior to initialization of a processing cycle, the system 100 can: execute an initial imaging routine to generate a nominal abrasion threshold representing baseline abrasion of a sanding pad 198 arranged on the sanding head 194 prior to application of the sanding head 194 at a work piece; and implement the nominal abrasion threshold during imaging routines executed during the processing cycle.

In one example, during a set up period, the system 100 can: navigate the sanding head 194 proximal the optical sensor 132 to locate an initial abrasive area of an initial sanding pad 198 within a field of view of the optical sensor 132; record an initial image of the initial abrasive area at the optical sensor 132; and extract an initial set of visual features from the initial image. Accordingly, the system 100 can implement steps and techniques described above to: interpret an initial abrasion for the initial abrasive area of the initial sanding pad 198 based on the initial set of visual features; and store the initial abrasion as the nominal abrasion threshold within internal memory of the controller 180.

Therefore, prior to initializing a processing cycle the system 100 can: access the nominal abrasion threshold from internal memory; and implement the nominal abrasion threshold during an imaging routine following a target time window in the processing cycle.

### 6. Wear Model+Tool Change Cycle

As described in U.S. application Ser. No. 18/136,241, filed on 18 Apr. 2023, which is hereby incorporated in its entirety by this reference, the system 100 can: access a first toolpath for a first workpiece region of a workpiece; access a first target force assigned to the workpiece; and access a wear model representing abrasive degradation of the first sanding pad 198 arranged on the sanding head 194. Additionally, during a processing cycle corresponding to application of the sanding head 194 on a workpiece proximal the work zone, the system 100 can: access a sequence of force values output by a force sensor coupled to the sanding head 194; navigate the sanding head 194 across the first workpiece region according to the first toolpath; and, based on the sequence of force values, deviate the sanding head 194 from the first toolpath to maintain forces of the sanding head 194 on the first workpiece region proximal the first target force.

The system 100 can then: access a first sequence of contact characteristics representing contact between the first abrasive area on the first sanding pad 198 and the workpiece; and estimate the first abrasive degradation of the first abrasive area based on the wear model and the first sequence of contact characteristics. Thus, in response to the first abrasive degradation exceeding a threshold degradation, the system 100 can: navigate the sanding head 194 proximal the optical sensor 132 to locate the first sanding pad 198 within a field of view of the imaging plane of the optical sensor 132; and trigger the optical sensor 132 to record the first image depicting the first abrasive area of the first sanding pad 198.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

1. A system for changing a sanding pad at a sanding head comprising:
a pad removal assembly comprising:
a separating element arranged proximal a first edge of a slot and configured to receive the sanding pad arranged on the sanding head; and
a guide surface arranged opposite the separating element and configured to guide the sanding pad arranged on the sanding head toward the separating element;
a deflector:
arranged opposite the separating element and below the guide surface;
arranged proximal a second edge opposite the first edge of the slot, the slot interposed between the separating element and the deflector;
comprising a rectangular geometry defining a vertical plane orthogonal to the guide surface and aligned to the second edge of the slot; and
configured to maintain the sanding pad in a target vertical pose during separation of the sanding pad from the sanding head and transition of the sanding pad through the slot;
a replacement pad reservoir:
arranged adjacent the separating element and housing a set of sanding pads configured to couple to the sanding head; and
comprising an aperture in alignment with the guide surface and configured to receive the sanding head within the replacement pad reservoir;
a first inspection unit comprising an optical sensor defining a field of view directed toward an imaging plane and configured to capture images of the sanding pad arranged on the sanding head; and
a controller configured to:
access a first image recorded by the optical sensor depicting a first abrasive area of a first sanding pad arranged on the sanding head in the imaging plane within a field of view of the optical sensor;
extract a first set of visual features from the first image;
interpret a first abrasive degradation for the first abrasive area in the first image based on the first set of features; and
in response to the first abrasive degradation exceeding a threshold degradation, triggering a tool change cycle to:
navigate the sanding head across the guide surface toward the separating element to remove the first sanding pad from the sanding head; and
navigate the sanding head within the replacement pad reservoir to engage a second sanding pad, in the set of sanding pads, within the replacement pad reservoir.

2. The system of claim 1:
further comprising:
a robotic arm arranged adjacent a work zone; and
an end effector:
arranged on a distal end of the robotic arm; and
comprising the sanding head configured to actuate the first sanding pad; and
wherein the controller is configured to, during the tool change cycle:
at a first time, navigate the sanding head to locate the first sanding pad in abutting contact with the guide surface;
maneuver the sanding head along a linear path across the guide surface toward a cutting edge of the separating element to separate the first sanding pad from the sanding head while guiding the first sanding pad through the slot;
at a second time following the first time, navigate the sanding head over the aperture of the replacement pad reservoir;
maneuver the sanding head through the aperture to apply a target force to the second sanding pad, in the set of sanding pads, contained within the replacement pad reservoir to engage the second sanding pad at the sanding head; and
initiate a processing cycle corresponding to application of the sanding head comprising the second sanding pad on a workpiece proximal the work zone.

3. The system of claim 2, wherein the controller is configured to:
at a third time following the second time, navigate the sanding head comprising the second sanding pad within the field of view of the optical sensor;
trigger the optical sensor to capture a second image depicting the second sanding pad arranged on the sanding head;
extract a second set of visual features from the second image;
interpret a second pose of the second sanding pad arranged on the sanding head based on the second set of features; and
in response to the second pose of the second sanding pad exceeding a threshold deviation from a target pose, triggering a second tool change cycle to:
navigate the sanding head across the guide surface toward the separating element to remove the second sanding pad from the sanding head; and
navigate the sanding head within the replacement pad reservoir to engage a third sanding pad, in the set of sanding pads, within the replacement pad reservoir at the sanding head.

4. The system of claim 2, wherein the controller is configured to:
during the processing cycle, navigate the sanding head comprising the second sanding pad within the field of view of the optical sensor;
trigger the optical sensor to capture a second image depicting a second abrasive area of the second sanding pad arranged on the sanding head;
extract a second set of visual features from the second image;
interpret a second abrasive degradation for the second abrasive area in the second image based on the second set of features; and
in response to the second abrasive degradation falling below a target abrasive degradation, resume the processing cycle according to the second abrasive degradation of the second sanding pad.

5. The system of claim 1:
wherein the optical sensor comprises an area imaging camera configured to capture color images of the sanding pad arranged on the sanding head within a field of view of the optical sensor; and
wherein the controller is configured to:
during a processing cycle, navigate the sanding head within the field of view of the optical sensor;
trigger the optical sensor to capture a first color image depicting the first sanding pad arranged on the sanding head;
isolate a first region in the first color image corresponding to the first abrasive area of the first sanding pad;
extract the first set of visual features from the first region;
generate a first wear map comprising a set of pixels representing a first degree of wear across the first abrasive area based on the first set of visual features from the first region;
interpret the first abrasive degradation across the first abrasive area based on differences between the first wear map and a baseline map representing a nominal wear across the first abrasive area; and
in response to the first abrasive degradation exceeding the threshold degradation, trigger the tool change cycle.

6. The system of claim 1:
wherein the optical sensor comprises a depth sensor configured to capture depth images of the sanding pad arranged on the sanding head within a field of view of the optical sensor; and
wherein the controller is configured to:
during a processing cycle, navigate the sanding head within the field of view of the depth sensor;
trigger the depth sensor to capture a first depth image depicting the first sanding pad arranged on the sanding head;
isolate a first region in the first depth image corresponding to the first abrasive area of the first sanding pad;
extract a first set of visual features from the first region;
generate a first depth map comprising a set of pixels representing a first surface profile across the first abrasive area of the first sanding pad based on the first set of visual features from the first region;
interpret the first abrasive degradation across the first abrasive area based on differences between the first depth map and a target depth map representing a target surface profile across the first abrasive area; and
in response to the first abrasive degradation exceeding the threshold degradation, trigger the tool change cycle.

7. The system of claim 1:
wherein the first inspection unit further comprises a set of lighting modules comprising a first lighting module comprising a bright-field light source and configured to output light normal the imaging plane; and
wherein the controller is configured to:
retrieve a timeseries of images from the optical sensor during a processing cycle corresponding to application of the sanding head on a work piece proximal the work zone;
detect presence of the sanding head within a field of view of the optical sensor in the timeseries of images; and
in response to detecting presence of the sanding head within a field of view of the optical sensor:
at a first time, trigger the first lighting module, in the set of lighting modules, to illuminate the first abrasive area of the first sanding pad at a first angle of incidence relative the first abrasive area;
extract the first image, from the timeseries of images, depicting the first abrasive area of the first sanding pad at the first time;
extract the first set of visual features from the first image; and
interpret the first abrasive degradation of the first abrasive area of the first sanding pad based on the first set of visual features from the first image.

8. The system of claim 7:
wherein the set of lighting modules further comprises a second lighting module:
comprising a dark-field light source; and
configured to output light substantially parallel to the imaging plane; and
wherein the controller is configured to, in response to detecting presence of the sanding head within a field of view of the optical sensor:
at a second time following the first time, trigger the second lighting module to illuminate the first abrasive area of the first sanding pad at a second angle of incidence, different the first angle of incidence, relative to the first abrasive area;
extract a second image, from the timeseries of images, depicting the first abrasive area of the first sanding pad at the second time;
extract a second set of visual features from the second image; and
interpret the first abrasive degradation of the first abrasive area of the first sanding pad based on the first set of visual features from the first image and the second set of visual features from the second image.

9. The system of claim 1:
wherein the guide surface defines a rectangular region and comprises a ceramic coating across the guide surface configured to protect the guide surface from the abrasive area of the first sanding pad;
wherein the slot extends across a first lateral side of the guide surface to define a channel interposed between the guide surface and the separating element; and
wherein the separating element comprises a blade comprising:
a spine coupled proximal the first edge of the slot; and
a cutting edge, opposite the spine, partially extending across the channel and configured to receive the first sanding pad arranged on the sanding head and guide the first sanding pad within the slot duration separation of the first sanding pad from the sanding head.

10. (canceled)

11. The system of claim 1:
wherein the replacement pad reservoir defines an internal surface forming a cylindrical volume configured to contain the set of sanding pads and comprises a first radial aperture arranged on a first end of the cylindrical volume; and
wherein the replacement pad reservoir further comprises:
a platform arranged within the replacement pad reservoir at a second end, opposite the first end, and configured to vertically support the set of sanding pads within the replacement pad reservoir;
a spring element arranged below the platform and vertically supporting the platform within the replacement pad reservoir; and
a guide ring arranged on the first end of the replacement pad reservoir in alignment with the guide surface and cooperating with the cylindrical volume to form a passageway configured to guide the sanding head toward the set of sanding pads arranged within the replacement pad reservoir.

12. The system of claim 11, wherein the pad removal assembly is arranged adjacent the replacement pad reservoir to form a unitary structure across the guide surface and a top end of the replacement pad reservoir.

13. The system of claim 11:
further comprising:
a robotic arm arranged adjacent a work zone; and
an end effector:
arranged on a distal end of the robotic arm; and
comprising the sanding head configured to actuate the first sanding pad; and
wherein the controller is configured to, during the tool change cycle:
at a first time, navigate the sanding head to locate the first sanding pad in abutting contact with the guide surface;
maneuver the sanding head along a linear path across the guide surface toward a cutting edge of the separating element to separate the first sanding pad from the sanding head while guiding the first sanding pad through the slot;
at a second time following the first time, navigate the sanding head concentrically over the guide ring of the replacement pad reservoir; and
maneuver the sanding head within the guide ring and toward the passageway of the replacement pad reservoir to couple a second sanding pad arranged within the replacement pad reservoir to the sanding head by applying a target force against the platform within the replacement pad reservoir supporting the second sanding pad.

14. The system of claim 1, wherein the controller is configured to, during an initial processing cycle corresponding to application of the sanding head on a work piece proximal a work zone:
navigate the sanding head proximal the optical sensor to locate an initial abrasive area of an initial sanding pad within a field of view of the optical sensor;
record an initial image of the initial abrasive area at the optical sensor;
extract an initial set of visual features from the initial image;
interpret an initial abrasion degradation for the initial abrasive area of the initial sanding pad based on the initial set of visual features; and
store the initial abrasive degradation as the threshold degradation within internal memory of the controller.

15. The system of claim 1:
further comprising:
a robotic arm arranged adjacent a work zone; and
an end effector:
arranged on a distal end of the robotic arm; and
comprising the sanding head configured to actuate the first sanding pad; and
wherein the controller is configured to:
access a first toolpath for a first workpiece region of a workpiece;
access a first target force assigned to the workpiece;
access a wear model representing abrasive degradation of the first sanding pad arranged on the sanding head; and
during a processing cycle corresponding to application of the sanding head on a workpiece proximal the work zone:
access a sequence of force values output by a force sensor coupled to the sanding head;
via a set of actuators coupled to the sanding head:
navigate the sanding head across the first workpiece region according to the first toolpath; and
based on the sequence of force values, deviate the sanding head from the first toolpath to maintain forces of the sanding head on the first workpiece region proximal the first target force;
access a first sequence of contact characteristics representing contact between the first abrasive area on the first sanding pad and the workpiece;
estimate the first abrasive degradation of the first abrasive area based on the wear model and the first sequence of contact characteristics; and
in response to the first abrasive degradation exceeding a threshold degradation:
navigate the sanding head proximal the optical sensor to locate the first sanding pad within a field of view of the imaging plane of the optical sensor; and
trigger the optical sensor to record the first image depicting the first abrasive area of the first sanding pad.

16. A system for changing a sanding pad at a sanding head comprising:
a separating element arranged proximal a first edge of a slot configured to receive the sanding pad arranged on the sanding head;
a guide surface arranged opposite the separating element configured to guide the sanding pad arranged on the sanding head toward the separating element;
a deflector:
arranged opposite the separating element and below the guide surface;
arranged proximal a second edge opposite the first edge of the slot, the slot interposed between the separating element and the deflector;
comprising a rectangular geometry defining a vertical plane orthogonal to the guide surface and aligned to the second edge of the slot; and
configured to maintain the sanding pad in a target vertical pose during separation of the sanding pad from the sanding head and transition of the sanding pad through the slot;
a replacement pad reservoir comprising an aperture in alignment with the guide surface and configured to receive the sanding head within the replacement pad reservoir;
an optical sensor defining a field of view directed toward an imaging plane and configured to capture images of the sanding pad arranged on the sanding head; and
a controller configured to:
retrieve a timeseries of images from the optical sensor following a target time window during a processing cycle corresponding to application of the sanding head on a work piece proximal the work zone;
detect presence of the sanding head within a field of view of the optical sensor in the timeseries of images;
identify a first image, from the timeseries of images, depicting a first abrasive area of a first sanding pad arranged on the sanding head;
extract a first set of visual features from the first image;
interpret a first abrasiveness of the first abrasive area of the first sanding pad based on the first set of visual features from the first image; and
in response to the first abrasiveness falling below a target abrasiveness, trigger a tool change cycle to:
navigate the sanding head across the guide surface toward the separating element to remove the first sanding pad from the sanding head; and
navigate the sanding head within the replacement pad reservoir to engage a second sanding pad, located within the replacement pad reservoir, at the sanding head.

17. The system of claim 16:
wherein the replacement pad reservoir defines an internal surface forming a cylindrical volume configured to contain a set of sanding pads and comprises a first radial aperture arranged on a first end of the cylindrical volume; and
wherein the replacement pad reservoir further comprises:
a platform arranged within the replacement pad reservoir at a second end, opposite the first end, and configured to vertically support the set of sanding pads within the replacement pad reservoir;
a spring element arranged below the platform and vertically supporting the platform within the cylindrical volume; and
a guide ring arranged on the first end of the replacement pad reservoir in alignment with the guide surface and cooperating with the cylindrical volume to form a passageway configured to guide the sanding head toward the set of sanding pads arranged within the replacement pad reservoir.

18. The system of claim 16:
wherein the guide surface defines a rectangular region and comprises a ceramic coating across the guide surface configured to protect the guide surface from the abrasive area of the first sanding pad;
wherein the slot extends across a first lateral side of the guide surface to define a channel interposed between the guide surface and the separating element; and
wherein the separating element comprises a blade comprising:
a spine coupled proximal the first edge of the slot; and
defining a cutting edge, opposite the spine, partially extending across the channel and configured to receive the first sanding pad arranged on the sanding head and guide the first sanding pad within the slot duration separation of the first sanding pad from the sanding head.

19. The system of claim 16:
further comprising a lighting module configured to output light toward the imaging plane; and
wherein the controller is configured to, in response to detecting presence of the sanding head within a field of view of the optical sensor:
at a first time, trigger the first lighting module, in the set of lighting modules, to illuminate the first abrasive area of the first sanding pad at a first angle of incidence relative the first abrasive area;
extract the first image, from the timeseries of images, depicting the first abrasive area of the first sanding pad at the first time;
extract the first set of visual features from the first image; and
interpret the first abrasiveness of the first abrasive area of the first sanding pad based on the first set of visual features from the first image.

20. A system for changing a sanding pad at a sanding head comprising:
a pad removal assembly comprising a separating element:
arranged adjacent a guide surface:
arranged proximal a slot extending across a first lateral side of the guide surface to define a channel interposed between the guide surface and the separating element; and
comprising a cutting edge extending partially across the channel from a first edge of the slot and configured to receive the sanding pad of the sanding head and guide the sanding pad through the slot;
a deflector:
arranged opposite the separating element and below the guide surface;
arranged proximal a second edge opposite the first edge of the slot, the slot interposed between the separating element and the deflector;
comprising a rectangular geometry defining a vertical plane orthogonal to the guide surface and aligned to the second edge of the slot; and
configured to maintain the sanding pad in a target vertical pose, orthogonal the guide surface, during separation of the sanding pad from the sanding head and transition of the sanding pad through the slot to prevent interference between the sanding pad and the separating element;
a replacement pad reservoir:
defining an internal surface forming a cylindrical volume configured to contain a set of sanding pads;
comprising a first radial aperture arranged on a top end of the replacement pad reservoir; and
comprising a guide ring arranged about the aperture of the replacement pad reservoir in alignment with the guide surface and cooperating with the cylindrical volume to form a passageway configured to guide the sanding head toward the set of sanding pads arranged within the replacement pad reservoir; and
a first inspection unit arranged proximal the replacement pad reservoir and comprising:
an optical sensor defining a field of view directed toward an imaging plane and configured to capture images of the sanding pad arranged on the sanding head; and
a first lighting module configured to output light toward the imaging plane.
